(19) United States
(12) Patent Application Publication
(10) Pub. No.: US 2004/0147163 A1
(43) Pub. Date: Jul. 29, 2004

(54) Electrical socket

(76) Inventor: James Chou, Taipei (TW)

Correspondence Address: JAMES CHOU, P.O.BOX 26-757, TAIPEI, 106, TW

(21) Appl. No.: 10/351,122

(22) Filed: Jan. 27, 2003

(51) Int. Cl. H01R 11/00

(52) U.S. Cl. 439/502

(57) ABSTRACT

An electrical socket has a movable socket holder, a casing and a socket body. The movable socket holder has a pair of jacks, with a curved contact pin is mounted in each jack. The casing has a pair of conductive pieces therein and an opening. The movable socket holder is movably mounted through the opening of the casing outside the casing. The socket body is mounted between the movable socket holder and the casing to either separate the contact pins from the conductive pieces to obtain an electrical disconnection, or contact with the contact pins and the conductive pieces to establish an electrical connection. The interior wiring of the electrical appliance can be safely controlled.

### BACKGROUND OF THE INVENTION

1. Field of the Invention

The invention relates to an electrical socket and, more particularly, to an electrical socket that allows easy electrical connection and disconnection.

2. Description of the Related Art

Domestic electrical power is usually supplied to a terminal electrical appliance via an electrical socket. The electrical socket may be provided with more than one pair of contact jacks through which the plug of the electrical appliance is inserted to be supplied with electrical power. However, the electric power load must be carefully controlled to prevent accidents caused by electric overload of the power line or the electrical socket. In order to achieve this purpose, the electrical socket is usually provided with a control mechanism for electrical disconnection and connection.

As illustrated in FIG. 4, a conventional electrical socket includes a casing 4 in which a plurality of jacks 40 is formed. A plurality of conductive pieces is respectively mounted through the corresponding jacks 40. A switch 41 is further mounted for controlling the electrical connection and disconnection of the conductive pieces.

In the above conventional electrical socket, the conductive pieces are fixed inside the casing with a contact tip of each conductive piece externally exposed. The control mechanism controls the conductive pieces and the contact tips. When an electrical connection is to be established, all the contact tips are connected to supply the electric power to the electrical appliance that is connected to the electrical socket. When an electrical disconnection is to be obtained, the tip contacts are electrically disconnected from the electrical appliance to ensure a safe power distribution and protect the electrical appliance from being damaged by any sudden electrical current flows. If more than one plug is inserted in the same electrical socket, the plug of one electrical appliance that is not currently in use has to be removed from the electrical socket to avoid an electrical overload.

### SUMMARY OF THE INVENTION

It is therefore a principal object of the invention to provide an electrical socket that allows easy electrical connection and disconnection.

It is another object of the invention to provide an electrical socket that allows a safe use of the electricity.

Furthermore, it is another object of the invention to provide an electrical socket that allows an electrical appliance to be switched on or off without needing to remove a plug thereof from the electrical socket.

To accomplish the above and other objectives, an electrical socket of the invention comprises a movable socket holder, a casing and a socket body. The movable socket holder has a pair of jacks. A curved contact pin is mounted in each jack of the movable socket holder. The casing has a pair of conductive pieces therein and an opening. The movable socket holder is movably mounted through the opening of the casing and is located outside the casing. The socket body is mounted between the movable socket holder and the casing, and separates the contact pins from the conductive pieces to obtain an electrical disconnection or contacts the contact pins and the conductive pieces to establish an electrical connection.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a perspective view of a conventional electrical socket;

FIG. 2 is an exploded view of an electrical socket according to a preferred embodiment of the invention;

FIG. 3 is a cross-sectional view of an electrical socket in electrical disconnection according to a preferred embodiment of the invention;

FIG. 4 is a cross-sectional view of an electrical socket in electrical connection according to a preferred embodiment of the invention;

FIG. 5 is a schematic view showing a position of a resilient hook of an electrical socket in electrical disconnection according to a preferred embodiment of the invention; and

FIG. 6 is a schematic view showing a position of a resilient hook of an electrical socket in electrical connection according to a preferred embodiment of the invention.

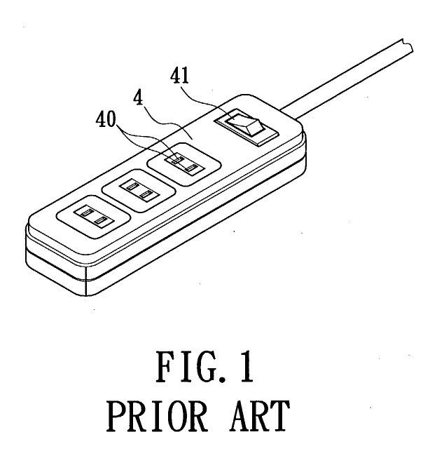

### DETAILED DESCRIPTION OF THE EMBODIMENTS

Wherever possible in the following description, like reference numerals will refer to like elements and parts unless otherwise illustrated.

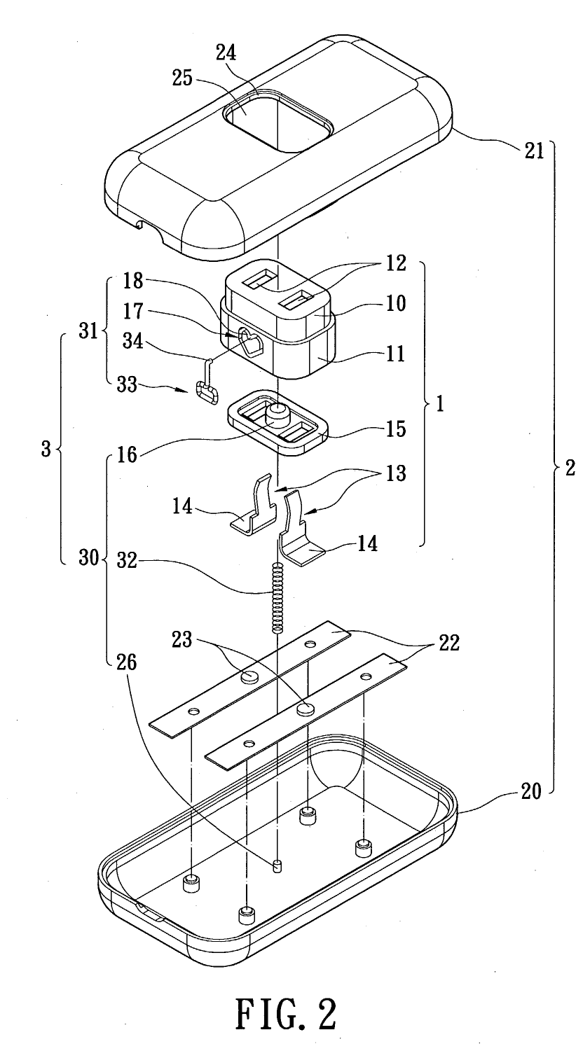

Referring to FIG. 2, an electrical socket according to one preferred embodiment of the invention includes a movable socket holder 1, a casing 2 and a socket body 3.

The movable socket holder 1 includes a plugging projection 10 and a projection base 11 having a periphery slightly larger than the plugging projection 10. The plugging projection 10 has a pair of jacks 12, and a pair of curved contact pins 13, each of the contact pins 13 having a substantially vertical tip portion 14. The contact pins 13 penetrate through a positioning plate 15 in a manner to align respectively with the jacks 12. The positioning plate 15 is thereby secured in an interior of the movable socket holder 1.

The casing 2 includes a lower casing 20 and an upper casing 21. The lower casing 20 has a pair of conductive pieces 22 each of which has an electrical contact 23 thereon. The upper casing 21 has an opening 24, a peripheral edge of which outwardly protrudes to form a collar 25. The collar 25 has an inner diameter larger than the opening 24. The movable socket holder 1 is movably mounted through the opening 24 by sliding the projection base 11 toward the collar 25. The upper casing 21 snap fits with the lower casing 20 in a manner to position the plugging projection outside the upper casing 21 through the opening 24.

The socket body 3 is mounted between the movable socket holder 1 and the casing 2. The socket body 3 includes a resilient mechanism 30 and a fixing mechanism 31. The resilient mechanism 30 includes a resilient member 32 such as a spring. A first stud 16 is mounted on the positioning plate 15 and a second stud 26 is mounted on an inner surface of the lower casing 20. The resilient member 32 is placed between the first and second studs 16, 26. The fixing mechanism 31 has an annular guide 17 at the projection base 11 of the movable socket holder 1. The annular guide 17 has a peak section 18 near the jacks 12. A resilient hook 33 is pivotally connected to the collar 25 of the casing 2. The resilient hook 33 has a hooking portion 34 that is able to slide in the annular guide 17.

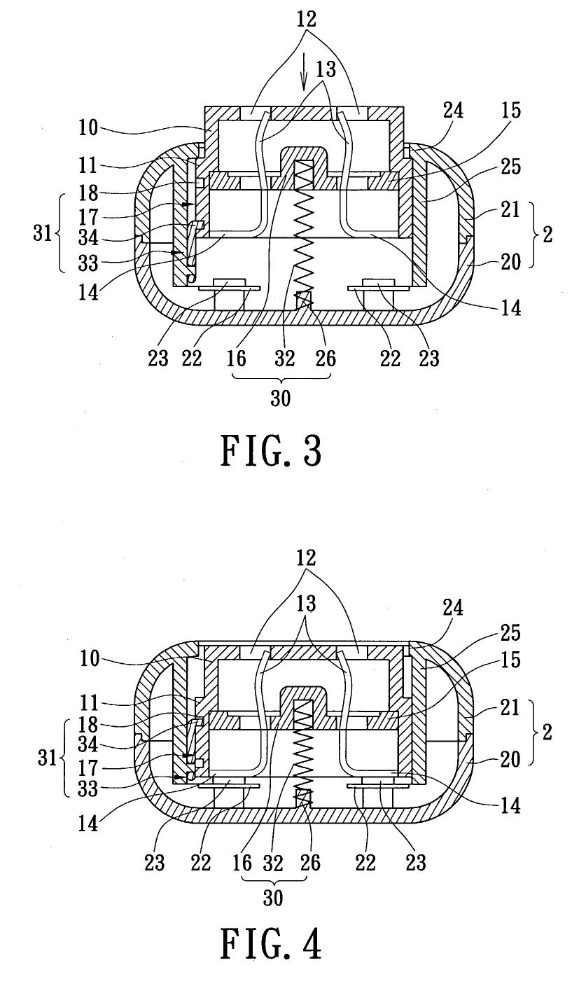

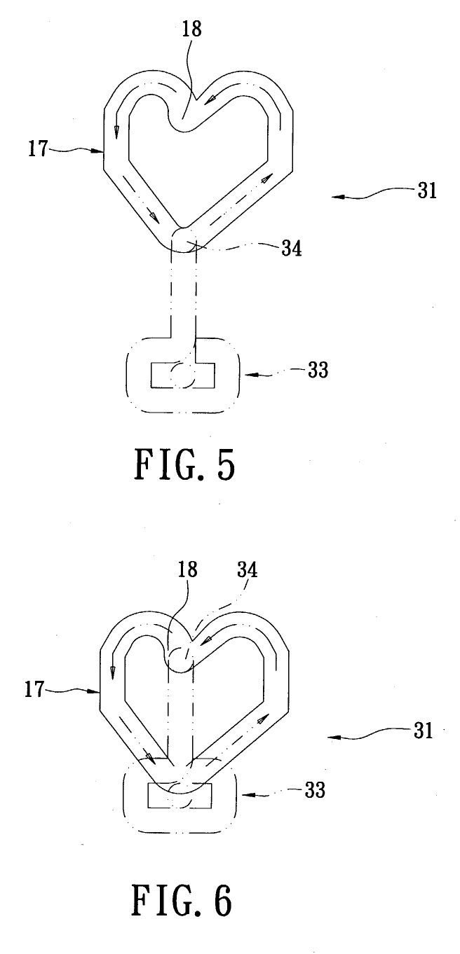

Referring to FIG. 3 and FIG. 5, the resilient member 32 of the socket body 3 pushes against the plugging projection 10 of the movable socket holder 1 until the plugging projection protrudes from the casing 2 through the opening 24. Furthermore, the resilient member 32 separates the contact pins 13 from the conductive pieces 22 to obtain an electrical disconnection. At this time, the hooking portion 34 of the resilient hook 33 leaves the peak section 18 of the annular guide 17.

Referring to FIG. 4 and FIG. 6, when a plug of an electrical appliance is inserted into the jacks 12 of the movable socket holder 1 to electrically connect to the contact pins 13, the movable socket holder 1 is pressed down to allow the hooking portion 34 of the resilient hook 33 to slide along the annular guide 17 to the peak section 18. Then, the hooking portion 34 is firmly engaged with the peak section 18 after the movable socket holder 1 is released. At this time, the plugging projection 10 is downwardly fixed so that the positioning plate 15 allows the contact pins 13 to move close to the conductive pieces 22 and the substantially vertical tip portion 14 comes in tight contact with the electrical contacts 23. Thereby, the socket body 3 electrically connects the contact pins 13 to the conductive pieces 22 to establish an electrical connection.

When the movable socket holder 1 is pressed down again, the hooking portion 34 of the resilient hook 33 slides outside the peak section 18 along the annular guide 17 to release the plugging projection 10. The resilient member 32 again separates the contact pins 13 from the conductive pieces 22 to obtain the electrical disconnection.

Switching the electrical socket is achieved by repeatedly contacting/separating the contact pins 13 and the conductive pieces 22. When the plug of the electrical appliance is inserted, the movable socket holder 1 is pressed down if the user wants to switch on the electrical appliance. When the electrical appliance is to be switched off, the movable socket holder 1 is pressed down again without needing to remove the plug of the electrical appliance. Therefore, with the electrical socket of the invention, all the interior wiring can be safely controlled and protected from being damaged by sudden current flows. Furthermore, the plug of the electrical appliance is less likely to be damaged. Electrically connecting and disconnecting are achieved by several simple components, so that the production cost of the electrical socket is reduced.

As described above, the electrical socket of the invention therefore provides the following advantages:

1. By using the resilient mechanism and the fixing mechanism of the socket body, the movable socket holder easily slides to obtain electrical connection or disconnection. The electrical socket can have more than one socket body. If the electrical socket has more than one socket body, each socket body can be individually operated without needing to remove the plug of the electrical appliance.

2. With the socket body and the movable socket holder, the electrical appliance is safely controlled when it is not in use to prevent any damage caused by sudden electrical current flows. This is achieved by releasing the movable socket holder to separate the contact pins from the conductive pieces.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An electrical socket comprising:
a movable socket holder, having a pair of jacks, wherein a curved contact pin is mounted in each jack;
a casing, having a pair of conductive pieces therein and an opening, wherein the movable socket holder is movably mounted through the opening in a manner to be located outside the casing; and
a socket body, mounted between the detachable socket holder and the casing, wherein the socket body separates the contact pins from the conductive pieces to obtain an electrical disconnection, or contacts the contact pins and the conductive pieces to establish an electrical connection.

2. The electrical socket of claim 1, wherein the movable socket holder comprises a plugging projection and a projection base having a periphery slightly larger than the plugging projection, the jacks of the movable socket holder passing through the plugging projection.

3. The electrical socket of claim 1, wherein each of the curved contact pins has a substantially vertical tip portion, the contact pins penetrating through a positioning plate in a manner to respectively align with the jacks of the movable socket holder.

4. The electrical socket of claim 1, wherein the casing comprises a lower casing and an upper casing, the lower casing having a pair of conductive pieces each of which has an electrical contact thereon, and the opening of the casing passing through the upper casing, with the lower casing snap fitting with the upper casing.

5. The electrical socket of claim 2, wherein a peripheral edge of the opening of the casing outwardly protrudes to form a collar having an inner diameter larger than the opening of the casing, the projection base sliding outside through the opening of the casing from the collar.

6. The electrical socket of claim 1, wherein the socket body includes a resilient mechanism, the resilient mechanism including a resilient member, a first stud being mounted on the positioning plate and a second stud in the casing, and the resilient member being located between the first and second studs.

7. The electrical socket of claim 1, wherein the socket body includes a fixing mechanism having an annular guide at a projection base of the movable socket holder, the annular guide having a peak section near the jacks of the movable socket holder, a resilient hook being pivotally connected to the casing, the resilient hook having a hooking portion able to slide in the annular guide, wherein:
when the hooking portion of the resilient hook leaves the peak section of the annular guide, the resilient member separates the contact pins from the conductive pieces to obtain an electrical disconnection; and
when the hooking portion is engaged with the peak section, the resilient member contacts the contact pins to establish an electrical connection.

8. The electrical socket of claim 6, wherein the resilient member is a spring.

9. The electrical socket of claim 6, wherein each of the curved contact pins has a substantially vertical tip portion, the contact pins penetrating through a positioning plate in a manner to align respectively with the jacks of the movable socket holder, the positioning plate being secured in an interior of the movable socket holder, the casing including a lower casing and an upper casing, and the second stud being located on an inner surface of the lower casing.

10. The electrical socket of claim 7, wherein the movable socket holder includes a plugging projection and a projection base having a periphery slightly larger than the plugging projection, the jacks of the movable socket holder being located through the plugging projection, a peripheral edge of the opening of the upper casing outwardly protruding to form a collar having an inner diameter larger than the opening, the projection base sliding outward from the collar through the opening, the annular guide of the fixing mechanism being located at the projection base, and the resilient hook of the casing being located on the collar.
